(19) United States
(12) Patent Application Publication
(10) Pub. No.: US 2007/0289695 A1
(43) Pub. Date: Dec. 20, 2007

(54) APPARATUS AND METHOD OF MANUFACTURING TAPE CARTRIDGE

(75) Inventor: Yasushi Hatano, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/762,572

(22) Filed: Jun. 13, 2007

(30) Foreign Application Priority Data
Jun. 15, 2006 (JP) 2006-165749

(51) Int. Cl. G03D 15/04

(52) U.S. Cl. 156/157; 156/502

(57) ABSTRACT

There is provided an apparatus and a method of manufacturing a tape cartridge. A leader tape member is cut off into a first leader tape and a second leader tape, and the second leader tape is held by a first movable vacuum block. One end of the first leader tape is joined to one end of a magnetic tape, and the magnetic tape of a required length is taken up on a reel in a magnetic tape cartridge, and then the other end of the magnetic tape is joined to one end of the second leader tape held by the first movable vacuum block. According to the apparatus and the method of manufacturing a tape cartridge, the leader tape member, which is previously taken up on the reel in the magnetic tape cartridge, is cut off into the first leader tape and the second leader tape, and both ends of the magnetic tape are joined to one end of the first leader tape and one end of the second leader tape, respectively.

### CROSS-REFERENCE TO RELATED APPLICATION(S)

This application claims the foreign priority benefit under Title 35, United States Code, §119 (a)-(d), of Japanese Patent Application No. 2006-165749, filed on Jun. 15, 2006 in the Japan Patent Office, the disclosure of which is herein incorporated by reference in its entirety.

### BACKGROUND OF THE INVENTION

1. Field of the Invention

The present invention relates to an apparatus and a method of manufacturing a tape cartridge, and more particularly to an apparatus and a method of manufacturing a single-reel type tape cartridge.

2. Description of the Related Art

A magnetic tape taken up in a single-reel type magnetic tape cartridge, which conforms to the LTO (Linear Tape Open) standard and is used for data storage, is configured, for example, such that a leader tape is joined to an end of a magnetic tape and a leader pin is attached on an end of the leader tape so as to pull out the magnetic tape from a tape cartridge.

In Japanese Laid-open Patent Application No. 2003-022648 (paragraphs 0027-0035, FIGS. 1, 3, 6, 8, 9, and 10), which discloses a conventional apparatus to manufacture the tape cartridge having the above-mentioned configuration, a magnetic tape of a required length is taken up on a reel contained in a tape cartridge, and then a leader tape is joined to an end of the magnetic tape, and then the leader tape is taken up on the reel. The leader tape is then cut off when the leader tape of a required length is taken up on the reel, and a leader pin is attached on an end of the leader tape.

The conventional tape cartridge manufacturing apparatus, however, has a problem such as high cost of equipment and large size of apparatus, because the apparatus need to have a supplying unit for supplying the leader tape to the tape cartridge or a control unit for controlling tension of the supplied leader tape.

The conventional apparatus also has a problem of low manufacturing efficiency because the supplying unit for supplying the leader tape is in a standby state during an operation of taking up the magnetic tape on the reel; the operation of taking up the magnetic tape on the reel takes most time in a process of manufacturing the magnetic tape cartridge.

In the conventional apparatus, when the magnetic tape is taken up on the reel, a hub of the reel, around which the magnetic tape is taken up, is applied with liquid, such as alcohol, at the beginning of taking up the magnetic tape on the reel, and thereby the magnetic tape is taken up on the reel with a leading end of the magnetic tape sticking to the hub with the liquid.

By the above-mentioned method of applying liquid on the hub, the applied liquid such as alcohol vaporizes or dries out before the magnetic tape, the leading end of which sticks to the hub with the liquid, is taken up on the reel. Therefore, when the magnetic tape is taken up on the reel, the leading end of the magnetic tape unsticks and is folded down or shifts in the width direction of the magnetic tape, so that a width-direction edge of the magnetic tape shifts on one of flanges provided on both ends of the hub.

When the magnetic tape is taken up around the hub, on which the surface of the magnetic tape becomes uneven because the leading end of the magnetic tape is folded down or shifts on the flange, there occurs local deformation on the magnetic tape further taken up on the uneven surface of the magnetic tape. The local deformation on the magnetic tape causes spacing loss between a servo write head and the magnetic tape when servo signals are written in the magnetic tape, and thereby causing writing or reading error of the servo signals and also recording or reproducing error of data.

### SUMMARY OF THE INVENTION

The present invention is accomplished to solve the above-mentioned problem, and the object of the present invention is to provide an apparatus and a method of manufacturing a tape cartridge, by which it is possible to prevent an increase in the size and the cost of an apparatus, low manufacturing efficiency, and local deformation on a magnetic tape.

According to one aspect of the present invention, there is provided an apparatus for manufacturing a tape cartridge. The tape cartridge comprises a reel contained in the tape cartridge, a tape to be taken up on the reel, and a leader tape member previously taken up on the reel. The leader tape member is cut off into a first leader tape and a second leader tape, and the first leader tape, the tape, and the second leader tape are taken up on the reel in series. The apparatus comprises a pull-out unit that pulls out the leader tape member from the tape cartridge, a cutting unit that cuts off the leader tape member pulled out from the tape cartridge into the first leader tape and the second leader tape, the first leader tape remaining on the tape cartridge side and the second leader tape being separated from the tape cartridge, a leader tape holding unit that holds the second leader tape, a tape joining unit that joins one end of the first leader tape to one end of the tape, and a leader tape joining unit that joins the other end of the tape to one end of the second leader tape held by the leader tape holding unit.

With such a configuration, it is possible to provide a tape cartridge manufacturing apparatus capable of automatically joining leading and trailing ends of the tape to the leader tapes by using the tape cartridge having the reel on which the leader tape is previously taken up.

According to another aspect of the present invention, there is provided a method of manufacturing a tape cartridge. The tape cartridge comprises a reel contained in the tape cartridge, a tape to be taken up on the reel, and a leader tape member previously taken up on the reel. The leader tape member is cut off into a first leader tape and a second leader tape, and the first leader tape, the tape, and the second leader tape are taken up on the reel in series. The method comprises the steps of pulling out the leader tape member from the tape cartridge, cutting off the leader tape member pulled out from the tape cartridge into the first leader tape and the second leader tape, the first leader tape remaining on the tape cartridge side and the second leader tape being separated from the tape cartridge, holding the second leader tape, joining one end of the first leader tape to one end of the tape, and joining the other end of the tape to one end of the second leader tape.

With such a configuration, it is possible to provide a method of manufacturing tape cartridge, which is capable of automatically joining leading and trailing ends of the tape to the leader tapes by using the tape cartridge having the reel on which the leader tape is previously taken up.

With the above configurations, which use the tape cartridge having the reel on which the leader tape is previously taken up, the tape cartridge manufacturing apparatus need not have a supplying unit for supplying the leader tape or a control unit for controlling tension of the leader tape.

Further, because taking up the leader tape on the reel and taking up the tape on the reel are carried out by separate operations, the supplying unit for supplying the leader tape are not in a standby state during the operation of taking up the tape on the reel; the operation of taking up the tape on the reel takes most time in a process of manufacturing the magnetic tape cartridge.

The leader tape is joined to a leading end of the tape, and therefore the tape is taken up on the reel through the leader tape. Thereby, the leader tape previously taken up on the reel is not folded down or does not shift on a flange of the reel, and therefore the tape followed by the leader tape does not have an uneven surface.

According to the present invention, an apparatus and a method of manufacturing a tape cartridge can be provided, by which it is possible to prevent an increase in the size and the cost of an apparatus, low manufacturing efficiency, and local deformation on a magnetic tape.

### BRIEF DESCRIPTION OF THE DRAWINGS

The object and features of the present invention will become more readily apparent from the following detailed description taken in conjunction with the accompanying drawings in which:

FIG. 1 is a front view of a magnetic tape cartridge manufacturing apparatus according to an embodiment of the present invention;

FIG. 2 is an exploded perspective view of a magnetic tape cartridge according to am embodiment of the present embodiment;

FIG. 3A illustrates a configuration of a reel and FIG. 3B illustrates that a leader tape member is sandwiched between an engaging piece and a reel according to an embodiment of the present invention;

FIG. 4 is a perspective view of a pulled-out tape holding table and a leader tape holding table according to an embodiment of the present invention;

FIG. 5 is a perspective view of a leader pin attaching device according to an embodiment of the present invention;

FIGS. 6A to 6D illustrate a leader tape pull-out device according to an embodiment of the present invention, FIG. 6A is a lateral view of a leader tape pull-out device, FIG. 6B illustrates a vacuum surface of a leader tape pull-out device as viewed from the bottom, FIG. 6C illustrates that a leader tape pull-out device vacuums an end of a leader tape member, and FIG. 6D illustrates that a leader tape pull-out device pulls out a leader tape member; and

FIG. 7A illustrates positions of a first movable vacuum block and a second movable vacuum block at the start of a taking-up operation, FIG. 7B illustrates that a leader tape member is vacuumed onto a fixed vacuum block and a first movable vacuum block, FIG. 7C illustrates that a leader tape member is cut off, FIG. 7D illustrates that a cut end of a leader tape member faces an end of a magnetic tape, FIG. 7E illustrates that a leader tape member (a first leader tape) is joined to a magnetic tape, FIG. 7F illustrates that a magnetic tape is cut off, and FIG. 7G illustrates that a magnetic tape is joined to a leader tape member (a second leader tape).

### DETAILED DESCRIPTION OF THE PREFERRED EMBODIMENT

Hereinafter, detailed description will be provided for an embodiment of the present invention with reference to attached drawings.

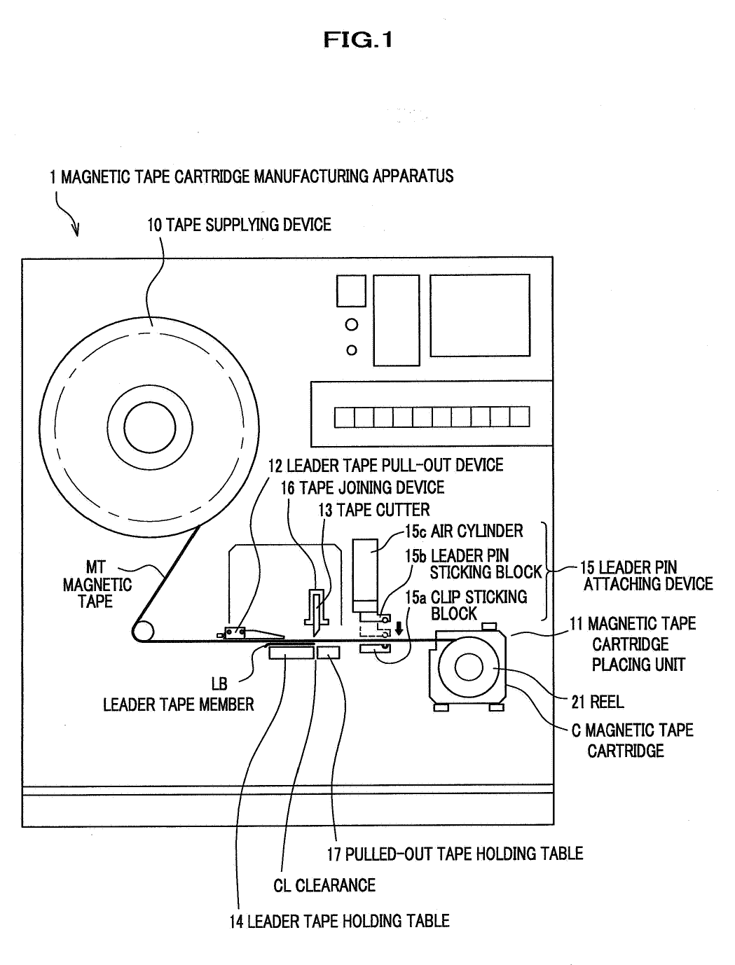

FIG. 1 is a front view of a magnetic tape cartridge manufacturing apparatus (a tape cartridge manufacturing apparatus) according to an embodiment of the present invention. In this embodiment, description will be provided by using a magnetic tape and a magnetic tape cartridge (a tape and a tape cartridge).

A magnetic tape cartridge manufacturing apparatus 1 is an apparatus for taking up a magnetic tape MT on a reel 21 in a magnetic tape cartridge C. The magnetic tape cartridge manufacturing apparatus 1 includes a tape supplying device 10, a magnetic tape cartridge placing unit 11, a leader tape pull-out device 12 (a pull-out unit), a tape cutter 13 (a cutting unit), a leader tape holding table 14 (a leader tape holding unit), a leader pin attaching device 15 including a clip sticking block 15a, a leader pin sticking block 15b, and a air cylinder 15c, a tape joining device 16 (a tape joining unit and a leader tape joining unit), and a pulled-out tape holding table 17 (a pulled-out tape holding unit). The tape supplying device 10 feeds the prepared magnetic tape MT to the magnetic tape cartridge C. The magnetic tape cartridge placing unit 11 securely holds the magnetic tape cartridge C, in which no magnetic tape MT is taken up. The leader tape pull-out device 12 pulls out a leader tape member LB previously taken up on the reel 21, which is rotatably contained in the magnetic tape cartridge C, from the magnetic tape cartridge C. The tape cutter 13 cuts off the leader tape member LB pulled out from the magnetic tape cartridge C and the magnetic tape MT fed from the tape supplying device 10. The leader tape holding table 14 holds the cut-off leader tape member LB. The leader pin attaching device 15 attaches a leader pin LP on one end of the leader tape member LB. The tape joining device 16 joins the leader tape member LB to the magnetic tape MT. The pulled-out tape holding table 17 holds the leader tape member LB pulled out from the magnetic tape cartridge C by the leader tape pull-out device 12.

The leader tape holding table 14 also has a function of holding the magnetic tape MT fed from the tape supplying device 10.

Preferably, the leader pin attaching device 15, the pulled-out tape holding table 17, and the leader tape holding table 14 are serially arranged in order in the direction, to which the leader tape member LB is pulled out from the magnetic tape cartridge C, which is securely disposed in the magnetic tape cartridge placing unit 11.

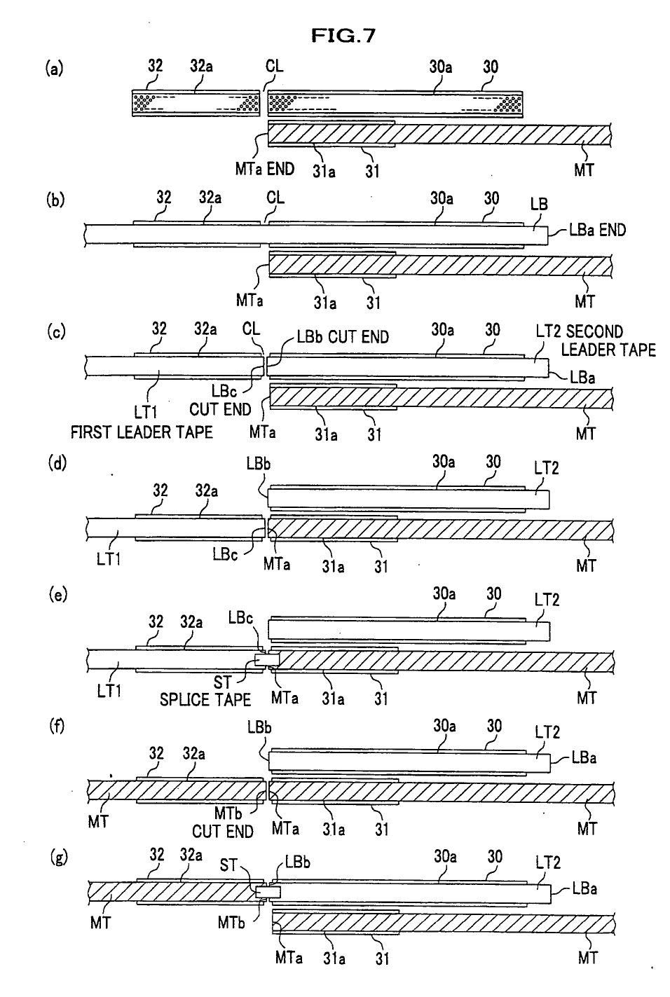

The leader tape member LB is cut off into a first leader tape LT1 and a second leader tape LT2 by the tape cutter 13, and the first leader tape LT1 and the second leader tape LT2 are joined to ends of the magnetic tape MT (see FIG. 7C). The leader tape member LB has the same width as that of the magnetic tape MT. For example, a conventional magnetic tape, which is thicker than the magnetic tape MT, is used as the leader tape member LB, but tapes other than the magnetic tape may be used as the leader tape member LB.

The tape supplying device 10 feeds the magnetic tape MT to be taken up on the reel 21 contained in the magnetic tape cartridge C. The tape supplying device 10 includes a reel for feeding a magnetic tape, on which the magnetic tape MT is taken up in a pancake shape. The tape supplying device 10 rotates at a predetermined rotation speed by an unshown rotation device so that the tape supplying device 10 feeds the magnetic tape MT to the magnetic tape cartridge C.

The magnetic tape cartridge placing unit 11 securely holds the magnetic tape cartridge C in the magnetic tape cartridge manufacturing apparatus 1. The magnetic tape cartridge placing unit 11 has the function of holding the magnetic tape cartridge C and also rotating the reel 21, which is rotatably contained in the magnetic tape cartridge C, by an unshown rotation device.

The tape cutter 13 cuts off the magnetic tape MT or the leader tape member LB with an unshown blade at the boundary of the leader tape holding table 14 and the pulled-out tape holding table 17. The tape cutter 13 is movable close to or apart from the surface of the magnetic tape MT or the leader tape member LB by an unshown drive device. The tape cutter 13 is disposed in a position such that the unshown blade of the tape cutter 13 is inserted into a clearance CL provided at the boundary of the leader tape holding table 14 and the pulled-out tape holding table 17 when the tape cutter 13 is close to the surface of the magnetic tape MT or the leader tape member LB.

The tape cutter 13 is moved closer to the surface of the magnetic tape MT or the leader tape member LB, which lies across the clearance CL provided at the boundary of the leader tape holding table 14 and the pulled-out tape holding table 17, and cuts off the magnetic tape MT or the leader tape member LB by the unshown blade, which is inserted into the clearance CL.

The tape joining device 16 joins an end of the magnetic tape MT to an end of the leader tape member LB when the magnetic tape MT and the leader tape member LB are held by the leader tape holding table 14 and the pulled-out tape holding table 17. The tape joining device 16 is positioned at the boundary of the leader tape holding table 14 and the pulled-out tape holding table 17. The tape joining device 16 holds a short splice tape ST at the end thereof in such a manner that an adhesive side of the splice tape ST (see FIG. 7E) faces the magnetic tape MT and the leader tape member LB.

The tape joining device 16 can be in contact with or apart from the surfaces of the magnetic tape MT and the leader tape member LB, which are held by the leader tape holding table 14 and the pulled-out tape holding table 17, by an unshown drive device.

The tape joining device 16 contacts the surfaces of the magnetic tape MT and the leader tape member LB, which are separately held by the leader tape holding table 14 and the pulled-out tape holding table 17 at the boundary thereof, and then joins the magnetic tape MT to the leader tape member LB by the splice tape ST (see FIG. 7E).

The tape cutter 13 and the tape joining device 16 are respectively positioned at the boundary (the vertical position of the clearance CL) of the leader tape holding table 14 and the pulled-out tape holding table 17. For example, the tape cutter 13 and the tape joining device 16 are positioned vertically relative to the leader tape holding table 14 and the pulled-out tape holding table 17, and the tape cutter 13 and the tape joining device 16 are moved in the vertical direction (vertically relative to the drawing of FIG. 1) relative to the leader tape holding table 14 and the pulled-out tape holding table 17 by an unshown drive device.

With this configuration, the tape cutter 13 is moved to the vertical position of the clearance CL by the unshown drive device when the tape cutter 13 cuts off the leader tape member LB or the magnetic tape MT, and the tape joining device 16 is moved to the vertical position of the clearance CL by the unshown drive device when the tape joining device 16 joins the leader tape member LB to the magnetic tape MT.

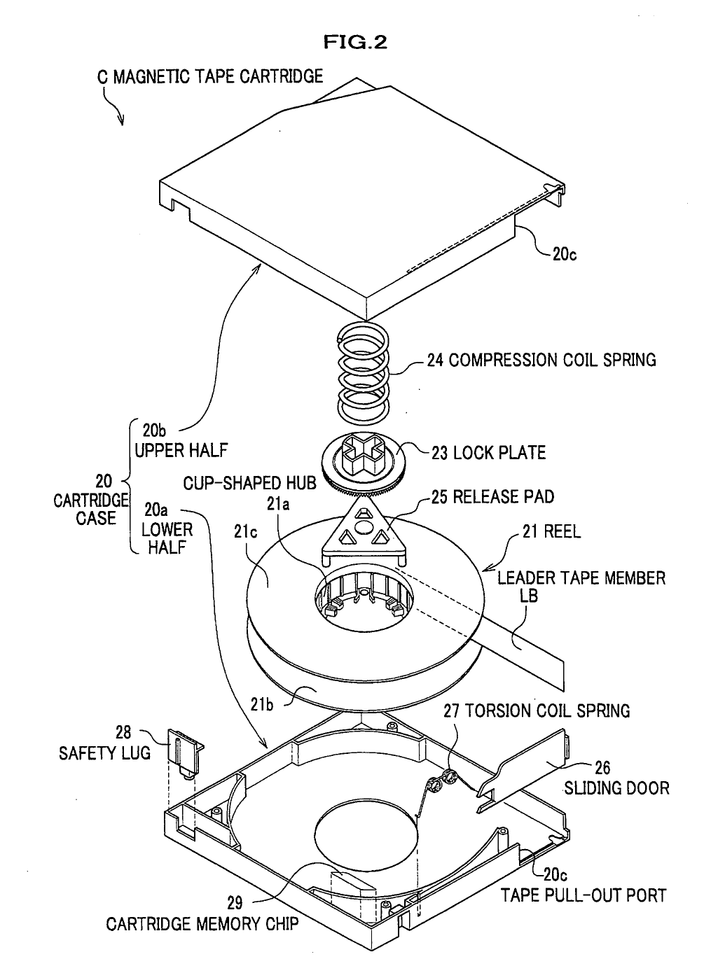

FIG. 2 is an exploded perspective view of a magnetic tape cartridge to be used in the present embodiment. The magnetic tape cartridge C includes the single reel 21, a lock plate 23, a compression coil spring 24, a release pad 25, a sliding door 26, a torsion coil spring 27, a safety lug 28, a cartridge memory chip 29, or the like, which are contained in a cartridge case 20 that includes a lower half 20a and an upper half 20b, as shown in FIG. 2. The lock plate 23 and the compression coil spring 24 are designed to lock the rotation of the reel 21. The release pad 25 is designed to release the locking of the reel 21. The sliding door 26 is open and closed in a tape pull-out port 20c formed in the lower half 20a and the upper half 20b of the cartridge case 20. The torsion coil spring 27 biases the sliding door 26 to the closed position of the tape pull-out port 20c.

The above-mentioned configuration of the magnetic tape cartridge C is only an example, and the configuration of the magnetic tape cartridge C is not limited to that of the above description.

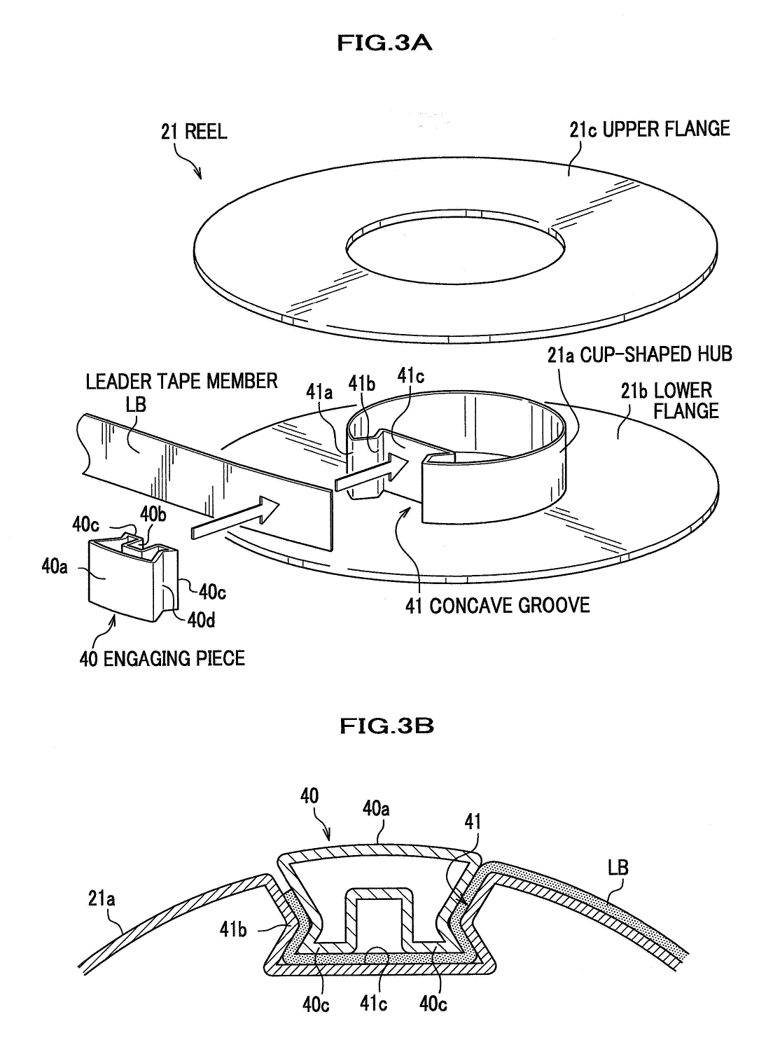

FIGS. 3A and 3B illustrate a configuration of a reel according to an embodiment of the present invention. As shown in FIG. 3A, the reel 21 includes a cup-shaped hub 21a, a lower flange 21b, an upper flange 21c, and an engaging piece 40. The cup-shaped hub 21a has an opening on the side of the upper half 20b (see FIG. 2). The lower flange 21b is connectedly formed with the hub 21a on the side of the lower half 20a (see FIG. 2). The upper flange 21c is welded to the opening of the hub 21a. The engaging piece 40 engages with the hub 21a.

Until the magnetic tape cartridge C is completed, the leader tape member LB is taken up around the cup-shaped hub 21a. After the magnetic tape cartridge C is completed, the first leader tape LT1, the magnetic tape MT, and the second leader tape LT2 are taken up around the hub 21a (see FIG. 7C).

The cup-shaped hub 21a is a cylindrical member having an opening on a side of the upper half 20b and a bottom on the other side. The release pad 25, the lock plate 23, and the compression coil spring 24 are assembled one by one in the hub 21a. On the outer circumference surface of the hub 21a is formed a concave groove 41, which the engaging piece 40 is fitted into. The concave groove 41 includes an opening portion 41a, a middle portion 41b, and a bottom portion 41c, and the middle portion 41b has a narrower width than those of the opening portion 41a and the bottom portion 41c (see FIGS. 3A and 3B).

The engaging piece 40 engages with the hub 21a to hold the leader tape member LB therebetween. The engaging piece 40 includes a curved surface portion 40a, a cutout portion 40b, and engaging portions 40c, 40c. The curved surface portion 40a has substantially the same curvature as that of the outer circumference surface of the hub 21a. The cutout portion 40b is formed on the opposite side of the curved surface portion 40a (on the side of the bottom portion 41c). The engaging portions 40c, 40c are formed on both sides of the cutout portion 40b. Side surfaces 40d of the engaging portions 40c, 40c are constricted so as to correspond to the shape of the middle portion 41b of the concave groove 41.

The engaging portion 40 engages with the concave portion 41 of the hub 21a to hold one end of the leader tape member LB, as shown in FIG. 3B, so that the leader tape member LB is fixed on the hub 21a.

The cup-shaped hub 21a may not have the concave groove 41, and one end of the leader tape member LB may be fixed on the outer circumference surface of the hub 21a with tape or the like.

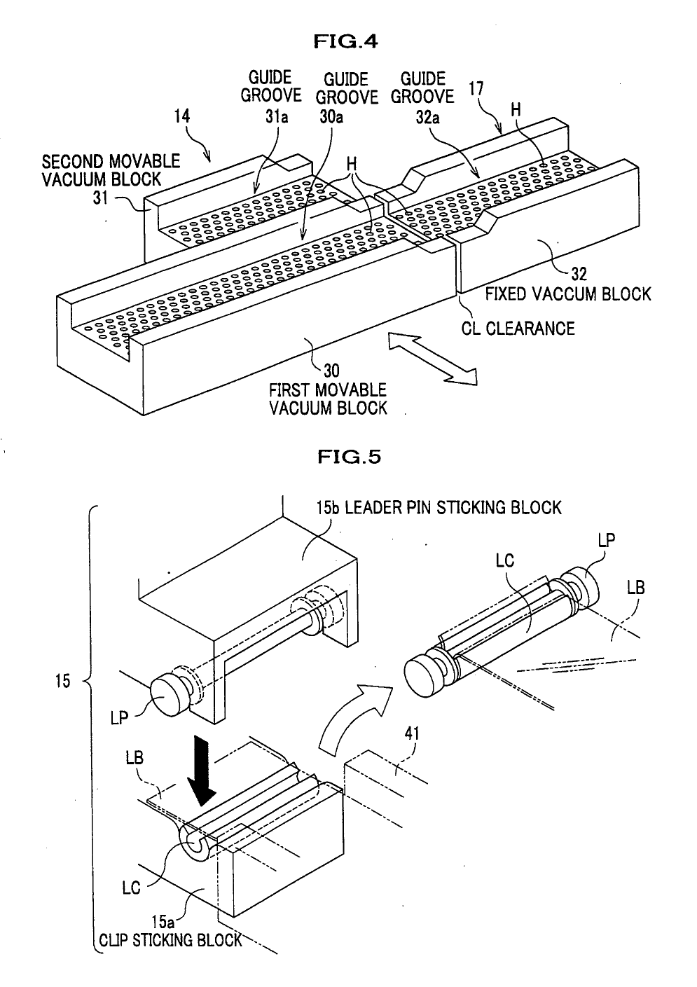

FIG. 4 is a perspective view of a pulled-out tape holding table and a leader tape holding table. The pulled-out tape holding table 17 includes a fixed vacuum block 32 (a fixed holding unit). The leader tape holding table 14 includes a first movable vacuum block 30 (a first movable holding unit) and a second movable vacuum block 31 (a second movable holding unit), which are movable in the direction of an arrow as shown in FIG. 4.

On the upper surface of the fixed vacuum block 32 is formed a guide groove 32a having the width that corresponds to the widths of the magnetic tape MT and the leader tape member LB. On the bottom surface of the guide groove 32a is formed a plurality of negative pressure vents H, through which the magnetic tape MT and the leader tape member LB are vacuumed onto the guide groove 32a. Each of the negative pressure vents H communicates with a negative pressure source through a switching valve (not shown), and the negative pressure is supplied or stopped in accordance with an operation of the switching valve. With this configuration, the magnetic tape MT and the leader tape member LB are vacuumed onto the guide groove 32a of the fixed vacuum block 32.

According to the embodiment shown in FIG. 4, the first movable vacuum block 30 and the second movable vacuum block 31 are arranged side-by-side in the width direction of the tape and are integrally formed. Guide grooves 30a, 31a are arranged side-by-side and parallel to each other in the width direction of the tape on the upper surfaces of the first movable vacuum block 30 and the second movable vacuum block 31. The guide grooves 30a, 31a have the same width and depth as that of the guide groove 32a of the fixed vacuum block 32. Because the first movable vacuum block 30 is defined to be longer in the longitudinal direction than the second movable vacuum block 31, the guide groove 30a is longer in the longitudinal direction than the guide grove 31a. Similarly to the guide groove 32a of the fixed vacuum block 32, a plurality of negative pressure vents H are formed on the bottom surfaces of the guide grooves 30a, 31a. Each of the negative pressure vents H communicates with a negative pressure source through a switching valve (not shown), and a negative pressure is supplied or stopped in accordance with an operation of the switching valve. With this configuration, the leader tape member LB is vacuumed onto the guide groove 30a of the first movable vacuum block 30 and the magnetic tape MT is vacuumed onto the guide groove 31a of the second movable vacuum block 31.

The above-mentioned switching valve operates separately for the first movable vacuum block 30, the second movable vacuum block 31 and the fixed vacuum block 32, and a negative pressure can be supplied or stopped separately for the first movable vacuum block 30, the second movable vacuum block 31 and the fixed vacuum block 32.

As mentioned above, the first movable vacuum block 30 and the second movable vacuum block 31 are integrally formed and arranged adjacent to each other with the clearance CL provided between the first movable vacuum block 30 and the fixed vacuum block 32 or the second movable vacuum block 31 and the fixed vacuum block 32, so that the blade (not shown) of the tape cutter 13 (see FIG. 1) is inserted into the clearance CL. The first and second movable vacuum blocks 30, 31 are movable back and forth in the width direction of the tape by an unshown drive device. Specifically, the first movable vacuum block 30 moves from an operation position where the guide groove 30a of the first movable vacuum block 30 and the guide groove 32a of the fixed vacuum block 32 meet in a line to a retreated position, which is provided on one side of the width direction (e.g. the front side in FIG. 4). The second movable vacuum block 31 moves from an operation position where the guide groove 31a of the second movable vacuum block 31 and the guide groove 32a of the fixed vacuum block 32 meet in a line to a retreated position, which is provided on the other side of the width direction (e.g. the back side in FIG. 4).

FIG. 5 is a perspective view of a leader pin attaching device according to an embodiment of the present invention. As shown in FIG. 5, the leader pin attaching device 15 has the function of engaging a leader pin clip LC with the leader pin LP so that the leader pin clip LC and the leader pin LP sandwiches an end portion (an end of a certain length) of the leader tape member LB. For performing the above-mentioned function, the leader pin attaching device 15 includes a clip sticking block 15a to stick the leader pin clip LC on the upper surface of the clip sticking block 15a and the leader pin sticking block 15b to stick the leader pin LP on the lower surface of the leader pin sticking block 15b.

As shown in FIG. 5, the clip sticking block 15a and the leader pin sticking block 15b are vertically arranged to face each other in the longitudinal direction thereof so as to sandwich the leader tape member LB in the width direction of the leader tape member LB. The leader pin sticking block 15b is supported by the air cylinder 15c (see FIG. 1), and thereby the leader pin sticking block 15b moves downwardly in the direction of an arrow as shown in FIG. 5 (in the direction of an arrow shown in the center of FIG. 1).

The leader pin sticking block 15b sticking the leader pin LP moves downwardly, and then the leader pin clip LC and the leader pin LP are engaged with each other to sandwich the end portion (the end of a certain length) of the leader tape member LB.

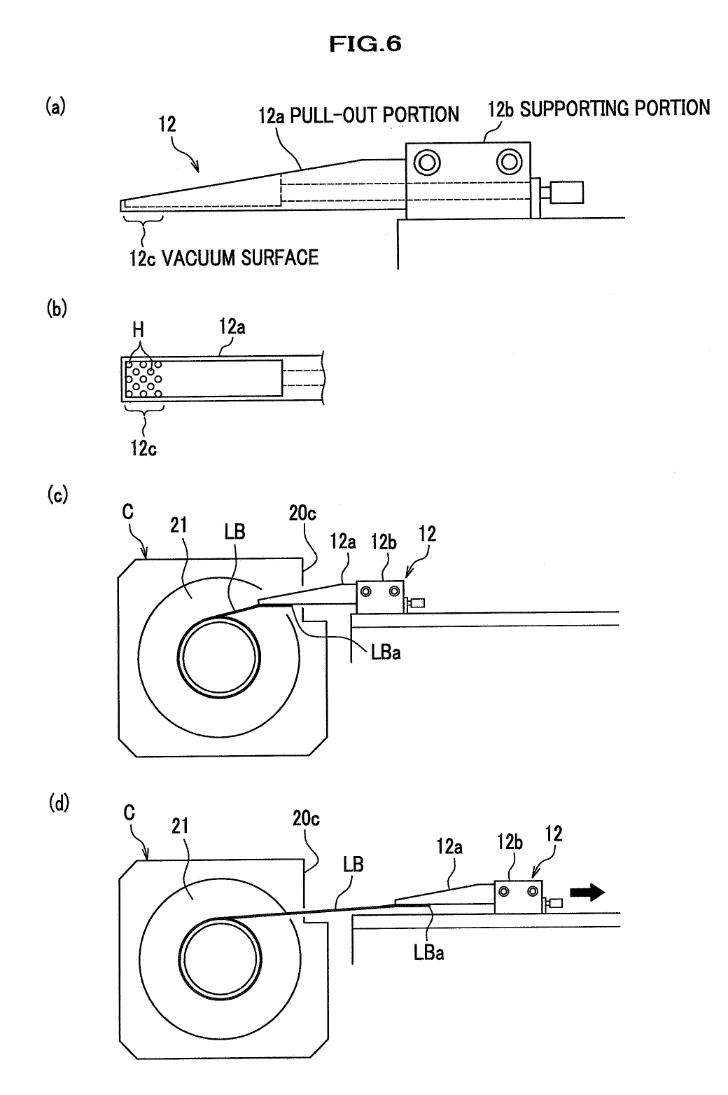

FIGS. 6A to 6D illustrate a leader tape pull-out device according to the embodiment of the present invention. As shown in FIG. 6A, the leader tape pull-out device 12 includes a supporting portion 12b and a pull-out portion 12a that is provided in a protruding manner on the supporting portion 12b. As shown in FIG. 6B, on an end portion of the pull-out portion 12a is formed a vacuum surface 12c having a plurality of negative pressure vents H to vacuum the leader tape member LB.

Each of the negative pressure vents H of the vacuum surface 12c communicates with a negative pressure source (not shown) through the supporting portion 12b and through the switching valve (not shown), and a negative pressure is supplied or stopped in accordance with an operation of the switching valve. With this configuration, the pull-out portion 12a vacuums an end LBa of the leader tape member LB taken up on the reel 21 of the magnetic tape cartridge C.

Further, the leader tape pull-out device 12 is movable back and forth between the magnetic tape cartridge C and the leader tape holding table 14 (see FIG. 1) by an unshown drive device.

While the magnetic tape cartridge C is securely disposed in the magnetic tape cartridge placing unit 11 shown in FIG. 1, the leader tape member LB taken up on the reel 21 is pulled out by the leader tape pull-out device 12. When the magnetic tape cartridge C is securely disposed in the magnetic tape cartridge placing unit 11, the end LBa of the leader tape member LB taken up on the reel 21 is positioned on the side of the tape pull-out port 20c of the magnetic tape cartridge C (on the approximately upper side in FIG. 6C).

As shown in FIG. 6C, the pull-out portion 12a moves inside the magnetic tape cartridge C through the tape pull-out port 20c, and then the vacuum surface 12c comes closer to the end LBa of the leader tape member LB taken up on the reel 21. Then, the unshown switching valve operates to supply the negative pressure to the vacuum surface 12c of the pull-out portion 12a, so that the vacuum surface 12c vacuums the end LBa of the leader tape member LB by the negative pressure generated through the negative pressure vents H of the vacuum surface 12c. FIGS. 6C and 6D illustrate the inside of the magnetic tape cartridge C transparently through the magnetic tape cartridge C and the flange of the reel 21.

As shown in FIG. 6D, the leader tape pull-out device 12 moves toward the leader tape holding table 14 (see FIG. 1) (to the right direction in FIG. 6D), so that the leader tape member LB of a desired length is pulled out from the magnetic tape cartridge C.

Preferably, an unshown rotation device of the magnetic tape cartridge placing unit 11 rotates the reel 21 at a rotation speed synchronized with a movement speed of the leader tape pull-out device 12, so as to feed the leader tape member LB from the magnetic tape cartridge C.

In the magnetic tape cartridge manufacturing apparatus 1 configured as mentioned above, as shown in FIG. 7A, the guide groove 30a of the first movable vacuum block 30 is moved to the operation position where the guide groove 30a and the guide groove 32a of the fixed vacuum block 32 meet in a line. The guide groove 31a of the second movable vacuum block 31, which is moved to the retreated position from the operation position, vacuums the magnetic tape MT fed from the tape supplying device 10 (see FIG. 1) by the negative pressure generated through the negative pressure vents H. An end MTa of the magnetic tape MT lies in the approximately same position as the end of the second movable vacuum block 31 on the block 32 side. An operation starts on the above-mentioned initial condition.

With reference to FIGS. 1 to 7, description will be provided for an operation procedure to take up the magnetic tape MT, the first leader tape LT1, and the second leader tape LT2, which leader tapes are formed from the leader tape member LB, on the reel 21 of the magnetic tape cartridge C.

To start the taking-up operation, the magnetic tape cartridge C is securely disposed in the magnetic tape cartridge placing unit 11 of the magnetic tape cartridge manufacturing apparatus 1. The magnetic tape cartridge C contains the reel 21 on which the leader tape member LB is taken up, and the leader tape member LB will be cut off into the first and second leader tapes LT1, LT2.

Preferably, the leader tape member LB is previously taken up on the reel 21 of the magnetic tape cartridge C more than twice as long as the outer circumference of the cup-shaped hub 21a (see FIG. 2).

When the magnetic tape cartridge C is place in the magnetic tape cartridge placing unit 11 and then the taking-up operation starts, the leader tape pull-out device 12 moves toward the magnetic tape cartridge C and the pull-out portion 12a moves inside the magnetic tape cartridge C through the tape pull-out port 20c.

When the vacuum surface 12c of the pull-out portion 12a comes closer to the end LBa of the leader tape member LB taken up on the reel 21, the unshown switching valve operates to supply the negative pressure for the vacuum surface 12c, and the vacuum surface 12c vacuums the end LBa of the leader tape member LB by the negative pressure generated through the negative pressure vents H of the vacuum surface 12c.

The vacuum surface 12c of the leader tape pull-out device 12 vacuums the end LBa of the leader tape member LB and moves toward the leader tape holding table 14 (to the left direction in FIG. 1) by an unshown drive device.

The unshown rotation device of the magnetic tape cartridge placing unit 11 rotates the reel 21 at a rotation speed synchronized with a movement speed of the leader tape pull-out device 12 so as to feed the leader tape member LB from the magnetic tape cartridge C.

The leader tape pull-out device 12 pulls out the end LBa of the leader tape member LB up to the vicinity of the end of the first movable vacuum block 30 on the opposite side to the fixed vacuum block 32. Then, the leader tape pull-out device 12 stops moving.

Then, the leader tape member LB pulled out from the magnetic tape cartridge C crosses over the clearance CL provided between the first movable vacuum block 30 and the fixed vacuum block 32, and lies along the guide grooves 30a and 32a, as shown in FIG. 7B.

An unshown switching valve then operates to supply the negative pressure to the first movable vacuum block 30 and the fixed vacuum block 32, so that the guide groove 30a of the first movable vacuum block 30 and the guide groove 32a of the fixed vacuum block 32 vacuum the leader tape member LB by the negative pressure generated through the negative pressure vents H of the guide grooves 30a and 32a.

Then, an unshown switching valve operates to stop supplying the negative pressure to the vacuum surface 12c of the pull-out portion 12a, thereby releasing the end LBa of the leader tape member LB from the vacuum surface 12c.

The tape cutter 13 (see FIG. 1) is moved closer to the surface of the leader tape member LB by the drive device (not shown), and then cuts off the leader tape member LB by inserting the blade (not shown) into the clearance CL between the first movable vacuum block 30 and the fixed vacuum block 32. As a result, as shown in FIG. 7C, the leader tape member LB is divided into two leader tape members LB, that is, the leader tape member LB vacuumed on the guide groove 32a of the fixed vacuum block 32 and the leader tape member LB vacuumed on the guide groove 30a of the first movable vacuum block 30, so that the leader tape members LB are provided with cut ends LBc, LBb, respectively.

The cut-off leader tape member LB, which is vacuumed on the guide groove 32a of the fixed vacuum block 32, is defined to be a first leader tape LT1, and the cut-off leader tape member LB, which is vacuumed on the guide groove 30a of the first movable vacuum block 30, is defined to be a second leader tape LT2.

When the second leader tape LT2 is vacuumed onto the guide groove 30a of the first movable vacuum block 30 and the magnetic tape MT fed from the tape supplying device 10 is vacuumed onto the guide groove 31a of the second movable vacuum block 31, the first movable vacuum block 30 and the second movable vacuum block 31 are moved by the unshown drive device. Thereby, the magnetic tape MT and the first leader tape LT1 vacuumed on the guide groove 32a of the fixed vacuum block 32 meet in a line, and the cut end LBc of the first leader tape LT1 faces the end MTa of the magnetic tape MT.

Specifically, the first movable vacuum block 30 and the second movable vacuum block 31 are moved upward as shown in FIGS. 7C and 7D (the front side as shown in FIG. 4).

Next, as shown in FIG. 7E, the cut end LBc of the first leader tape LT1 and the end MTa of the magnetic tape MT are joined to each other with the splice tape ST by the tape joining device 16.

The switching valve (not shown) operates to stop supplying the negative pressure to the fixed vacuum block 32 and the second movable vacuum block 31 so as to turn off the negative pressure generated through the negative pressure vents H of the guide grooves 32a, 31a. Then, the first leader tape LT1 and the magnetic tape MT are released from the guide grooves 32a, 31a.

An unshown rotation device of the magnetic tape cartridge placing unit 11 rotates the reel 21 in the magnetic tape cartridge C to take up the first leader tape LT1 on the reel 21, and the rotation device continuously rotates the reel 21 in the same direction to take Lip the magnetic tape MT, which is joined to the first leader tape LT1, on the reel 21, followed by the first leader tape LT1.

The magnetic tape MT slides along the guide groove 31a of the second movable vacuum block 31 and the guide groove 32a of the fixed vacuum block 32 so as to be taken up on the reel 21.

When the magnetic tape MT of a required length is taken up on the reel 21, the rotation device of the magnetic tape cartridge placing unit 11 stops rotating the reel 21. The magnetic tape MT lies along the guide grooves 31a, 32s across the clearance CL between the second movable vacuum block 31 and the fixed vacuum block 32.

The switching valve (not shown) operates to supply the negative pressure to the fixed vacuum block 32 and the second movable vacuum block 31 so as to generate the negative pressure through the negative pressure vents H of the guide grooves 31a, 32a. Thereby, the magnetic tape MT is vacuumed onto the guide grooves 31a, 32a.

The tape cutter 13 (see FIG. 1) is moved closer to the surface of the magnetic tape MT by the drive device (not shown), and then cuts off the magnetic tape MT by inserting the blade (not shown) into the clearance CL between the second movable vacuum block 31 and the fixed vacuum block 32. As a result, as shown in FIG. 7F, the magnetic tape MT is provided with a cut end MTb.

The magnetic tape MT vacuumed on the guide groove 31a of the second movable vacuum block 31 is provided with a cut end, which will be the end MTa of the magnetic tape MT of the magnetic tape cartridge C to be manufactured next.

When the magnetic tape MT is vacuumed onto the guide groove 31a of the second movable vacuum block 31 and the guide groove 32a of the fixed vacuum block 32, the first movable vacuum block 30 and the second movable vacuum block 31 are moved by the unshown drive device. Thereby, the second leader tape LT2 vacuumed on the guide groove 30a of the first movable vacuum block 30 and the magnetic tape MT vacuumed on the guide groove 32a of the fixed vacuum block 32 meet in a line, and the cut end MTb of the magnetic tape MT faces the cut end LBb of the second leader tape LT2.

Specifically, the first movable vacuum block 30 and the second movable vacuum block 31 are moved downward as shown in FIGS. 7F and 7G (the back side as shown in FIG. 4).

Next, as shown in FIG. 7G, the cut end MTb of the magnetic tape MT and the cut end LBb of the second leader tape LT2 are joined to each other with the splice tape ST by the tape joining device 16.

The switching valve (not shown) operates to stop supplying the negative pressure to the first movable vacuum block 30 and the fixed vacuum block 32 so as to turn off the negative pressure generated through the negative pressure vents H of the guide grooves 30a, 32a. Then, the second leader tape LT2 and the magnetic tape MT are released from the guide grooves 30a and 32a, respectively.

The unshown rotation device of the magnetic tape cartridge placing unit 11 rotates the reel 21 in the magnetic tape cartridge C to take up the magnetic tape MT on the reel 21, and the rotation device continuously rotates the reel 21 to take up the second leader tape LT2, which is joined to the magnetic tape MT, on the reel 21.

When the end LBa of the second leader tape LT2 comes close to the leader pin attaching device 15, the rotation device of the magnetic tape cartridge placing unit 11 stops rotating the reel 21 to stop taking up the second leader tape LT2 on the reel 21.

As mentioned above, the leader pin sticking block 15b of the leader pin attaching device 15 is moved downwardly by the air cylinder 15c, and the end LBa of the second leader tape LT2 is vertically sandwiched between the leader pin sticking block 15b and the clip sticking block 15a, so that the leader pin clip LC engages with the leader pin LP to fix the leader pin LP at the end LBa of the second leader tape LT2 (see FIGS. 1 and 5).

When the leader pin LP is fixed at the end LBa of the second leader tape LT2, the unshown rotation device of the magnetic tape cartridge placing unit 11 rotates the reel 21 again to take up the second leader tape LT2 on the reel 21.

When the leader pin LP attached on the second leader tape LT2 engages the tape pull-out port 20c (see FIG. 2) of the magnetic tape cartridge C, the unshown rotation device of the magnetic tape cartridge placing unit 11 stops rotating the reel 21, and thereby the taking-up of the magnetic tape MT in the magnetic tape cartridge C is completed.

The above description has been provided for the preferred embodiment of the present invention. However, the present invention is not limited to the above-mentioned embodiment, and any modifications or changes may be made within the scope of the present invention.

For example, in the embodiment of the present invention, the first movable vacuum block 30 and the second movable vacuum block 31 are arranged horizontally parallel to each other and are moved in the horizontal direction so that the leader tape member LB and the magnetic tape MT are faced to each other. However, the first movable vacuum block 30 and the second movable vacuum block 31 may be arranged vertically parallel to each other (so-called a two-storied structure) and moved in the vertical direction so that the leader tape member LB and the magnetic tape MT are faced to each other.

The embodiment of the present invention has been described by using the magnetic tape as an example. However, the present invention is not limited to the magnetic tape and may be used for manufacturing other tape recording medium, such as optical recording medium. The present invention may be used for manufacturing other tape products.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An apparatus for manufacturing a tape cartridge,
the tape cartridge comprising:
a reel contained in the tape cartridge;
a tape to be taken up on the reel; and
a leader tape member previously taken up on the reel, the leader tape member being to be cut off into a first leader tape and a second leader tape, and the first leader tape, the tape, and the second leader tape being to be taken up on the reel in series,
the apparatus comprising:
a pull-out unit that pulls out the leader tape member from the tape cartridge;
a cutting unit that cuts off the leader tape member pulled out from the tape cartridge into the first leader tape and the second leader tape, the first leader tape remaining on the tape cartridge side and the second leader tape being separated from the tape cartridge;
a leader tape holding unit that holds the second leader tape;
a tape joining unit that joins one end of the first leader tape to one end of the tape; and
a leader tape joining unit that joins the other end of the tape to one end of the second leader tape held by the leader tape holding unit.

2. The apparatus for manufacturing a tape cartridge according to claim 1, further comprising a pulled-out tape holding unit that holds at least the leader tape member pulled out by the pull-out unit,
wherein the cutting unit cuts off the leader tape member at a clearance provided between the pulled-out tape holding unit and the leader tape holding unit, the leader tape member being held by the pulled-out tape holding unit and the leader tape holding unit across the clearance.

3. The apparatus for manufacturing a tape cartridge according to claim 2,
wherein the leader tape holding unit has a further function of holding the tape, and
the tape joining unit joins the first leader tape to the tape, when the first leader tape held by the pulled-out tape holding unit and the tape held by the leader tape holding unit meet in a line and an cut end of the first leader tape faces an end of the tape.

4. The apparatus for manufacturing a tape cartridge according to claim 2,
wherein the cutting unit has a further function of cutting the tape, and
the cutting unit cuts off the tape at the clearance provided between the pulled-out tape holding unit and the leader tape holding unit, the tape being held by the pulled-out tape holding unit and the leader tape holding unit across the clearance.

5. The apparatus for manufacturing a tape cartridge according to claim 2,
wherein the leader tape joining unit joins the tape to the second leader tape, when the tape taken up on the reel and held by the pulled-out tape holding unit and the second leader tape held by the leader tape holding unit meet in a line and a cut end of the tape faces an cut end of the second leader tape.

6. The apparatus for manufacturing a tape cartridge according to claim 3,
wherein the pulled-out tape holding unit includes a fixed holding unit,
the leader tape holding unit includes a first movable holding unit and a second movable holding unit, and
the first movable holding unit holds the second leader tape and the second movable holding unit holds the tape.

7. The apparatus for manufacturing a tape cartridge according to claim 6,
wherein the first movable holding unit and the second movable holding unit are integrally formed and are arranged parallel to each other along a direction to pull out the leading tape member by the pull-out unit.

8. The apparatus for manufacturing a tape cartridge according to claim 6,
wherein the leader tape holding unit moves from an operation position, in which the first movable holding unit and the fixed holding unit of the pulled-out tape holding unit meet in a line, to another operation position, in which the second movable holding unit and the fixed holding unit meet in a line.

9. The apparatus for manufacturing a tape cartridge according to claim 2,
wherein the pulled-out tape holding unit and the leader tape holding unit are respectively provided with guide grooves having a width that corresponds to widths of the tape and the leader tape member, and
the guide grooves are provided with a plurality of vents, and the leader tape member or the tape is vacuumed onto the guide grooves.

10. The apparatus for manufacturing a tape cartridge according to claim 1,
wherein a vacuum surface having a plurality of vents to vacuum the leader tape member is formed on an end portion of the pull-out unit, and the pull-out unit pulls out the leader tape from the tape cartridge by vacuuming an end of the leader tape member on the vacuum surface.

11. The apparatus for manufacturing a tape cartridge according to claim 1,
wherein an engaging piece is fitted into a concave groove formed on an outer circumference surface of a hub of the reel to hold one end of the leader tape member between the hub and the engaging piece, so that the leader tape member is fixed on the hub.

12. The apparatus for manufacturing a tape cartridge according to claim 1,
wherein a leader pin and a leader pin clip are engaged to sandwich an end portion of the second leader tape, so that the leader pin is attached on an end of the second leader tape.

13. The apparatus for manufacturing a tape cartridge according to claim 11,
wherein the leader tape member having a length of more than twice an outer circumference of the hub is previously taken up on the reel of the tape cartridge.

14. The apparatus for manufacturing a tape cartridge according to claim 1,
wherein the tape is a magnetic tape and the tape cartridge is a magnetic tape cartridge.

15. A method of manufacturing a tape cartridge including a reel contained in the tape cartridge, a tape to be taken up on the reel, and a leader tape member previously taken up on the reel, the leader tape member being to be cut off into a first leader tape and a second leader tape, and the first leader tape, the tape, and the second leader tape being to be taken up on the reel in series, the method using the tape cartridge manufacturing apparatus according to claim 1, the method comprising the steps of:
pulling out the leader tape member from the tape cartridge;
cutting off the leader tape member pulled out from the tape cartridge into the first leader tape and the second leader tape, the first leader tape remaining on the tape cartridge side and the second leader tape being separated from the tape cartridge;
holding the second leader tape;
joining one end of the first leader tape to one end of the tape; and
joining the other end of the tape to one end of the second leader tape.

16. A method of manufacturing a tape cartridge according to claim 15, comprising the step of joining one end of the first leader tape to one end of the tape,
wherein the leader tape member is cut off to form the first leader tape, and then the first leader tape and the tape meet in a line, thereby joining the first leader tape to the tape.

17. A method of manufacturing a tape cartridge according to claim 15, comprising the step of joining the other end of the tape to one end of the second leader tape,
wherein the cut-off tape and the second leader tape meet in a line, thereby joining the tape to the second leader tape.
